(19) United States
(12) Patent Application Publication
(10) Pub. No.: US 2003/0175030 A1
(43) Pub. Date: Sep. 18, 2003

(54) Re-configurable optical add/drop multiplexer module and method

(76) Inventors: Shuqiang Chen, Santa Rosa, CA (US); N. Patrick Wang, Sant Rosa, CA (US); Shanti Cavanaugh, Santa Rosa, CA (US); Igor Stouklov, Santa Rosa, CA (US); Niannan Cai, Vallejo, CA (US)

Correspondence Address: Strategic Patent Services, Inc., 1096 Trestle Glen, Oakland,, CA, 94610, US

(21) Appl. No.: 10/101,092

(22) Filed: Mar. 18, 2002

(51) Int. Cl. H04J 14/02

(52) U.S. Cl. 398/85; 398/74; 398/65; 398/93; 359/498

(57) ABSTRACT

A reconfigurable liquid crystal based optical add/drop multiplexer system and method are provided which incorporates switching, variable attenuation, and multiplexing/demultiplexing capabilities. In a preferred embodiment, an array of optical rails is provided such that the integration of multiplexing/demultiplexing, switching, and variable optical attenuation functionalities are achieved. The module is also able to perform add and drop functions independently. The system has no moving parts so that the module is durable and very reliable. The system may include a feedback system for performing channel equalization.

### FIELD OF INVENTION

This invention relates generally to a reconfigurable optical add/drop multiplexer module and in particular to a liquid crystal (LC) based optical add/drop multiplexer module that integrates switching, variable attenuation, and multiplexing/demultiplexing capabilities.

### BACKGROUND OF THE INVENTION

Optical add/drop multiplexer modules are needed for wavelength division multiplexed (WDM) optical networks in which one or more wavelength channels need to be dropped or added while preserving the integrity of other channels. Optical add/drop modules are well known and are classified as either fixed wavelength and as re-configurable (multiple wavelength) optical add/drop modules.

In fixed wavelength optical add/drop modules, the wavelength is selected and remains the same. FIGS. 1 and 2 show two examples of conventional fixed optical add/drop modules. In particular, FIG. 1 illustrates a conventional fixed wavelength optical add/drop module that uses thin film filters while FIG. 2 illustrates a conventional fixed wavelength optical add/drop module that uses fiber Bragg gratings. As shown in FIG. 1, an input signal of various different wavelengths (λ₁ . . . λₙ) is fed into an optical add/drop module 20 that permits a particular wavelength signal, λᵢ in this example, to be dropped from and/or added to the input signal based on the characteristics, Fᵢ, of the thin film filters 22. As shown in FIG. 2, two optical circulators 24, 26 and a fiber Bragg grating 28 at a particular wavelength (λᵢ in this example) may be used to add and/or drop a particular wavelength (λᵢ) signal from an input signal. The disadvantage of these fixed wavelength optical add/drop modules is that they are not switchable and cannot be used to add/drop different wavelength signals.

Due to the above problems and limitations of fixed wavelength optical add/drop modules, re-configurable optical add/drop modules are greatly desired for WDM networks having more than two nodes between which data is transmitted and, usually, selectively switched to other nodes according to wavelength. One conventional way to fabricate a reconfigurable optical add/drop module is to use 1) available wavelength demultiplexers, such as conventional gratings and array waveguide gratings to demultiplex all the channels onto individual fibers; 2) individual optomechanical 2×2 switches on each channel to configure the channel to pass the signal or add/drop the signal, and followed by the same number of variable optical attenuators (VOA) for the channel equalization; and 3) available wavelength multiplexers to re-multiplex all signals back onto a single fiber. Such a conventional reconfigurable optical add/drop module is shown in FIG. 3. The reconfigurable optical add/drop module 30 includes a demultiplexer 32, a multiplexer 34, a bank 36 of optomechanical 2×2 switches (one for each wavelength) and a bank 38 of VOAs (again one for each wavelength). Using these components, signals with different wavelengths can be added/dropped from the input signal. In fact several well known optical networking companies, such as JDS-Uniphase and Santec, have introduced their re-configurable optical add/drop module product based on 2×2 optomechanical switches. The drawback and limitation of these conventional opto-mechanical re-configurable optical add/drop modules is that, due to the moving parts within the optomechanical switches, the reliability and durability of the module may be suspect. Furthermore, assembling the 2×2 switches, VOAs, and multiplexers/demultiplexers together makes these products bulky and cost-ineffective.

There have been efforts to develop liquid crystal (LC) based add/drop modules, such as shown in U.S. Pat. No. 5,912,748 to Wu et al., assigned to Chorum Technologies and U.S. Pat. Nos. 6,137,606 and 6,285,478B1 to Wu et al. which also are assigned to Chorum Technologies. The first two patents involve wavelength router that could be used as one of basic elements in an OADM module, but it is not a fully functioning re-configurable OADM. The third one, U.S. Pat. No. 6,285,478B1, on the other hand, proposed a design of OADM module consisting of DEMUX/MUX and an add/drop switching matrix in the middle. The add/drop switching matrix comprises polarization beam splitters, birefringent crystals, and polarization rotators (e.g., LC cells), and is arranged in a way that the Input and Thru ports are aligned horizontally while the Add and Drop ports are aligned vertically. In this case, all channels need to be assembled as a single piece at the same time and one needs to perform optical alignment in both horizontal and vertical directions simultaneously. As one can imagine, manufacturing a module with the structure shown in U.S. Pat. No. 6,285,478B1 (FIG. 5) will be extremely difficult, and consequently the cost to manufacture will be very high.

In view of the above, there remains a need in the fiber optic communications industry for an easy to fabricate, more reliable and compact reconfigurable optical add/drop module and it is to this end that the present invention is directed.

### SUMMARY OF THE INVENTION

The reconfigurable optical add/drop module in accordance with the invention achieves many advantages over the typical add/drop systems including higher durability and reliability without moving parts. The system may comprise one or more switching rails (or optical add/drop modules) that handle a particular wavelength signal. The different embodiments have different techniques for separating the multiple wavelength incoming signal and then recombining the individual wavelength signals to output a single multiple wavelength signal. In one embodiment, thin film filters that separate and combine multiple wavelength signals are integrated with switching rails. The switching rails may also perform an attenuation function depending to the voltages applied to the pixels of the liquid crystal controlled switching (LCCS) elements. In accordance with the invention, each switching rail/optical add/drop module is independently controlled so that each optical signal having a particular wavelength can be independently added/dropped or passed through. The optical add/drop module in accordance with the invention is reconfigurable since the operation of each switching rail in the module is independently controlled.

In another embodiment, a by-passed 2×2 switch with variable optical attenuation (VOA) can be derived from the reconfigurable optical add/drop module by removing the thin film filters at the input collimators. Then, by combining an array of 2×2 switches with VOA and a pair of stand-alone WDM MUX/DEMUX, a reconfigurable optical add/drop module in accordance with the invention may also be assembled.

The variable optical attenuation (VOA) function of the reconfigurable optical add/drop module is realized by varying the driving voltage of an LC pixel that changes the attenuation of optical path. To automatically tune the attenuation level of each VOA, a feedback system is used to adjust the driving voltages of the LC pixels based on output channel intensity and desired intensity. There may be two different embodiments of the feedback system. One embodiment uses one 20 dB coupler and one detector for each channel to monitor channel intensity and then an electronic board varies the driving voltage of an LC pixel based on the detected intensity. This may be effective for a low channel count device. The other embodiment multiplexes all channels into a single fiber. The fiber with all channel signals is connected to a 20 dB coupler and then a tunable filter. A detector monitors optical signals while the tunable filter scans the wavelength range, and finally a control board feeds a proper voltage to an LC pixel. Similarly, an OSA module may be used as a part of feedback system.

Thus, in accordance with the invention, a LC based optical add/drop module (OADM) is designed to integrate switching, variable attenuation, and MUX/DEMUX functionalities. Taking advantage of LC technology, the module has no moving part and therefore offers excellent durability and reliability.

In accordance with the invention, a re-configurable optical add/drop multiplexing module for a multiple wavelength incoming signal is provided. The module has an array of wavelength selective switch rails that are connected together so that each switch rail processes an optical signal having a single wavelength and the array of switch rails process the incoming multiple wavelength signal. Each switch rail further comprises a dual fiber collimator with a WDM filter at a particular wavelength that receives a multiple wavelength signal and selects a particular wavelength signal and a single fiber collimator for adding a signal having the particular wavelength. Each switch rail also has a first birefringent element that splits the particular wavelength signal into orthogonal polarizations having a first polarization and a second polarization, a first rotator that receives the orthogonal polarization signals and performs one or more of switching the polarization of one of the orthogonal polarization signals and attenuates one of the orthogonal polarization signals, a second birefringent element that deflects the path of the orthogonal polarization signals that exit the first multi-pixel liquid crystal cell stack, a second multi-pixel liquid crystal cell stack that receives the orthogonal polarization signals from the second birefringent element and performs one or more of switching and attenuation, a third birefringent element that receives the orthogonal polarization signals from the second multi-pixel liquid crystal cell stack and recombines the orthogonal polarization signals, a regular collimator to collects a signal being dropped, and a dual fiber collimator with a WDM filter at the same wavelength that passes the particular wavelength signal.

In accordance with another aspect of the invention, a re-configurable optical add/drop multiplexing module for a multiple wavelength incoming signal is provided. The module comprises a wavelength de-multiplexer that divides the incoming multiple wavelength signal into a plurality of single wavelength signals and an array of switch rails that are connected together so that each switch rail processes an optical signal having a single wavelength and the array of switch rails process the incoming multiple wavelength signal. Each switch rail further comprises a single fiber collimator for adding a signal having the particular wavelength, a first birefringent element that splits the particular wavelength signal into orthogonal polarizations having a first polarization and a second polarization and a first rotator that receives the orthogonal polarization signals and performs one or more of switching the polarization of one of the orthogonal polarization signals and attenuates one of the orthogonal polarization signals. Each switch rail further comprises a second birefringent element that deflects the path of the orthogonal polarization signals that exit the first rotator, a second multi-pixel liquid crystal cell stack that receives the orthogonal polarization signals from the second birefringent element and performs one or more of switching and attenuation and a third birefringent element that receives the orthogonal polarization signals from the second rotator and recombines the orthogonal polarization signals to generate a particular wavelength output signal, a regular collimator to collects a signal being dropped. The module further comprises a wavelength multiplexer that combines the particular wavelength output signals from the array of switch rails to generate a multiple wavelength output signal.

In accordance with yet another aspect of the invention, a switch rail for a re-configurable optical add/drop multiplexing module is provided. The switch rail comprises a dual fiber collimator with a WDM filter at a particular wavelength that receives a multiple wavelength signal and selects a particular wavelength signal, a single fiber collimator for adding a signal having the particular wavelength and a first birefringent element that splits the particular wavelength signal into orthogonal polarizations having a first polarization and a second polarization. The switch rail further comprises a first rotator that receives the orthogonal polarization signals and performs one or more of switching the polarization of one of the orthogonal polarization signals and attenuates one of the orthogonal polarization signals and a second birefringent element that deflects the path of the orthogonal polarization signals that exit the first rotator. The switch rail further comprises a second rotator that receives the orthogonal polarization signals from the second birefringent element and performs one or more of switching and attenuation, a third birefringent element that receives the orthogonal polarization signals from the second multi-pixel liquid crystal cell stack and recombines the orthogonal polarization signals, a regular collimator to collects a signal being dropped, and a dual fiber collimator with a WDM filter at the same wavelength that passes the particular wavelength signal.

In accordance with still another aspect of the invention, a re-configurable optical add/drop multiplexing module for adding/dropping optical signals from an incoming multiple wavelength signal is provided that has one or more broadband switch rails. Each switch rail comprises two regular collimators as input ports, first block of birefringent crystal that splits incoming light into e- and o- rays, first multi-pixel liquid crystal (LC) cell stack that either switches or attenuates the light beam, a polarization dependent beam path deflector comprising a second block of birefringent crystal, second multi-pixel liquid crystal (LC) cell stack that performs switching and attenuating functions, third block of birefringent crystal that combines e- and o- rays, and two regular collimators as output ports. The module further comprises a demultiplexer that separates the incoming multiple wavelength signal into one or more single wavelength signals that are input into a respective one of the switch rails, and a multiplexer that receives the single wavelength output signals from the one or more switch rails and recombines the multiple output signals into a multiple wavelength output signal.

### BRIEF DESCRIPTION OF THE DRAWINGS

FIG. 1 illustrates a conventional fixed wavelength optical add/drop module that uses thin film filters to add/drop signals;

FIG. 2 illustrates a conventional fixed wavelength optical add/drop module that uses fiber Bragg gratings to add/drop signals;

FIG. 3 illustrates a conventional reconfigurable optical add/drop multiplexer (R-OADM) module that uses optomechanical 2×2 switches to add/drop signals;

FIG. 4A is a block diagram illustrating the functionality of a single wavelength optical add/drop module in accordance with the invention;

FIG. 4B is a block diagram illustrating the functionality of a multiple wavelength (broadband) optical add/drop module in accordance with the invention;

FIG. 5A is a schematic illustration of a single channel optical add/drop module switch rail in accordance with the invention in a first switching state that performs. add/drop functions;

FIG. 5B is a schematic illustration of a single channel optical add/drop module switch rail in accordance with the invention in a second switching state that allows the incoming signal to pass through the optical add/drop module;

FIGS. 5C and 5D are three dimensional representations of the single channel optical add/drop module switch rail in a first switching state that performs add/drop functions and in a second switching state that allows the incoming signal to pass through the optical add/drop module, respectively;

FIG. 6 is a schematic illustration of a first embodiment of a multi-channel reconfigurable optical add/drop module in accordance with the invention consisting of an array of single channel optical add/drop module switch rails wherein each channel handles a different wavelength;

FIG. 7A is a schematic illustration of a by-passed 2×2/VOA switch rail in accordance with the invention that is actually a single channel optical add/drop module rail that handles broadband signals in a first switching state that performs add/drop functions;

FIG. 7B is a schematic illustration of the by-passed 2×2/VOA switch rail in accordance with the invention in a second switching state that allows the incoming signal to pass through the optical add/drop module;

FIG. 8 is a schematic illustration of a second embodiment of a multi-channel reconfigurable optical add/drop module in accordance with the invention consisting an array of by-passed 2×2/VOA switch rails (shown in FIGS. 7A and 7B) and a pair of multiplexers/demultiplexers;

FIG. 9 is a schematic illustration of a third embodiment of a multi-channel reconfigurable optical add/drop module in accordance with the invention consisting an array of single channel optical add/drop module switch rails and a feedback system;

FIG. 10 is a schematic illustration of a fourth embodiment of a multi-channel reconfigurable optical add/drop module in accordance with the invention consisting an array of single channel optical add/drop module switch rails and a different feedback system; and

FIGS. 11A and 11B illustrate the operation of the variable optical attenuators (VOAs) shown in FIGS. 7A and 7B.

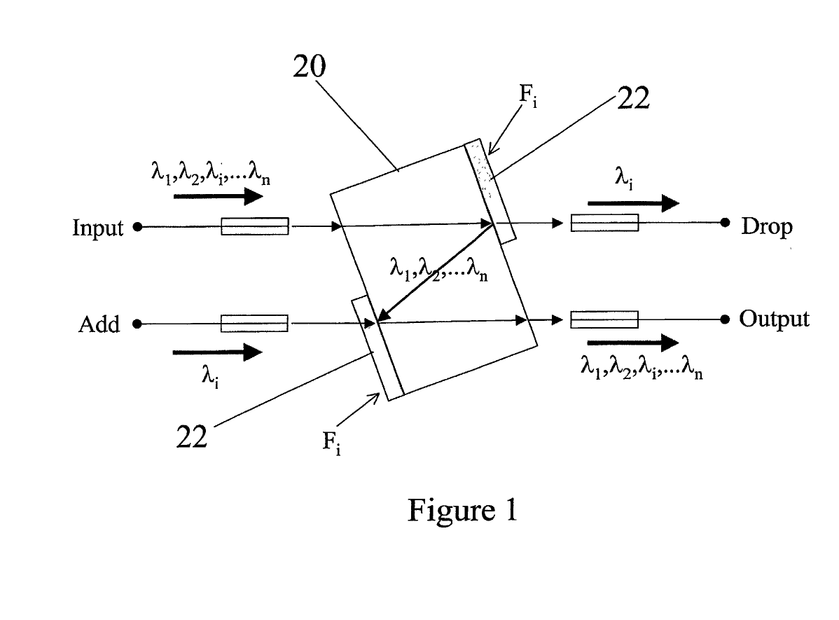

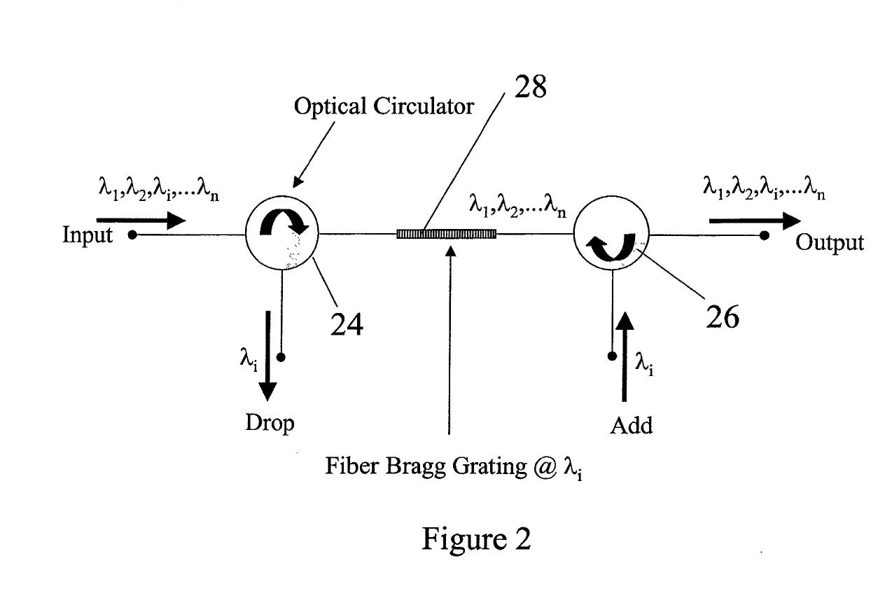

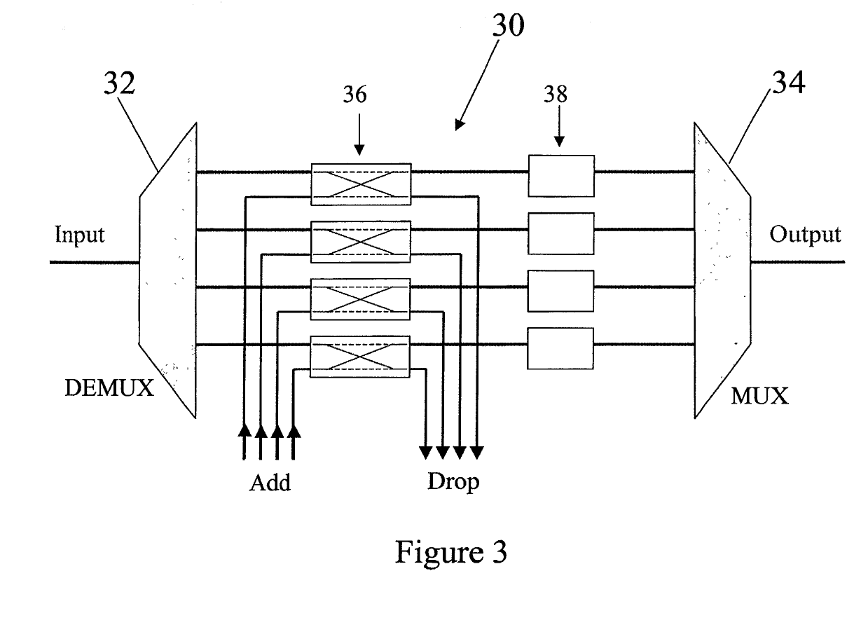

### DETAILED DESCRIPTION OF A PREFERRED EMBODIMENT

The invention is particularly applicable to a reconfigurable single or multiple wavelength optical add/drop module (with a single channel or multiple channels) and it is in this context that the invention will be described. It will be appreciated, however, that the module and method in accordance with the invention has greater utility, such as to other optical add/drop systems. To understand the invention, a block diagram illustrating the functionality of the preferred embodiments of the invention will be described. Then, a detailed description of the structure of the module in accordance with the invention will be described.

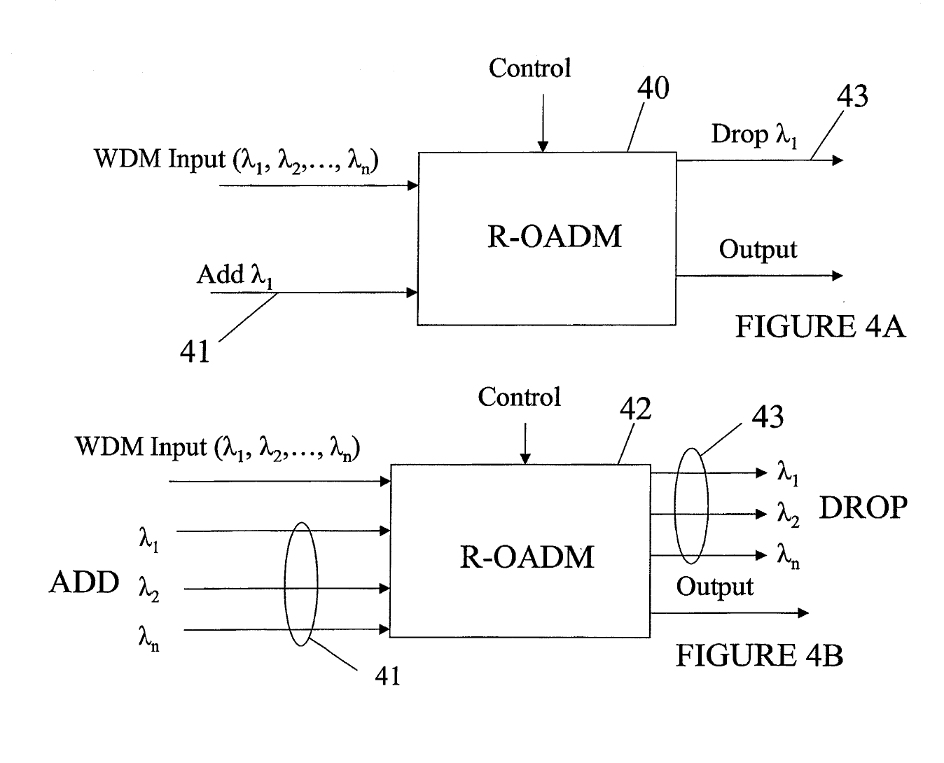

FIG. 4A is a block diagram illustrating the functionality of a single wavelength optical add/drop module 40 in accordance with the invention. The optical add/drop module 40 receives an input WDM system signal (as is well known) that typically comprises a plurality of signals having different wavelengths (λ₁, . . . , λₙ in this example) as shown. In this example, a signal having a particular wavelength (such as λ₁ in this example) can be added into or dropped from the WDM signal. The invention can also be used with any other types of signals in which it is desirable to add/drop signals from a multiple wavelength input signal (also known as a broadband signal). Returning to FIG. 4A, an add signal 41 is fed into the optical add/drop module having a particular wavelength, such as λ₁ in this example. The optical add/drop module 40 may be controlled by one or more control signals that are fed into the optical add/drop module 40 as shown. In response to the one or more control signals, the optical add/drop module may add or drop the particular wavelength signal from the WDM signal or permit the WDM signal to pass through the optical add/drop module 40 unaffected. The operation of the optical add/drop module 40 in accordance with the invention will be described in more detail below. The optical add/drop module 40 may output a drop signal 43 having a particular wavelength, such as λ₁ in this example, when the optical add/drop module 40 has been controlled by the one or more control signals and has dropped the signal from the input signal. The optical add/drop module 40 may also output an output signal wherein the output signal may be identical to the input signal, may have fewer signals than the input signal since a signal was dropped or may have more signals than the input signal since a signal was added into the output signal. The characteristics of the output signal depend on the one or more control signals as described below in more detail.

FIG. 4B is a block diagram illustrating the functionality of a multiple wavelength (broadband) optical add/drop module 42 in accordance with the invention which operates in a similar manner to the optical add/drop module 40 shown in FIG. 4A. The difference is that this optical add/drop module 42 is capable of adding/dropping multiple different wavelength signals from the input signal based on the one or more control signals. Thus, the same input signal is fed into the optical add/drop module 42. In addition, however, one or more add signals 41 with different wavelengths (λ₁, . . . , λₙ) are fed into the optical add/drop module since any or all of these signals can be added into the input signal. Similarly, the optical add/drop module 42 outputs one or more drop signals 43 of different wavelengths (λ₁, . . . , λₙ corresponding to signals being dropped from the incoming signal based on the one or more control signals. Now, a single channel, single wavelength optical add/drop module in accordance with the invention and its structure will be described in more detail.

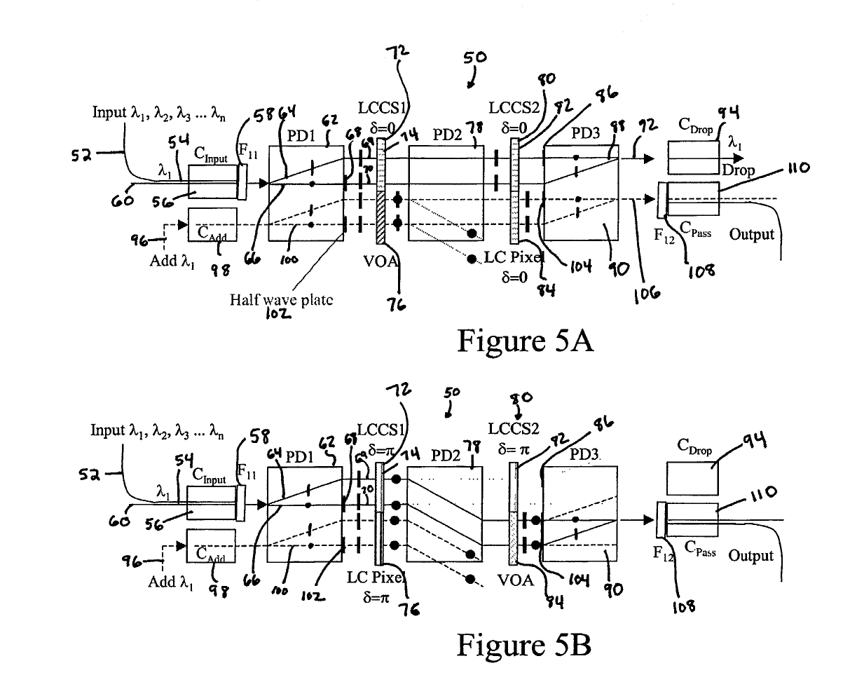

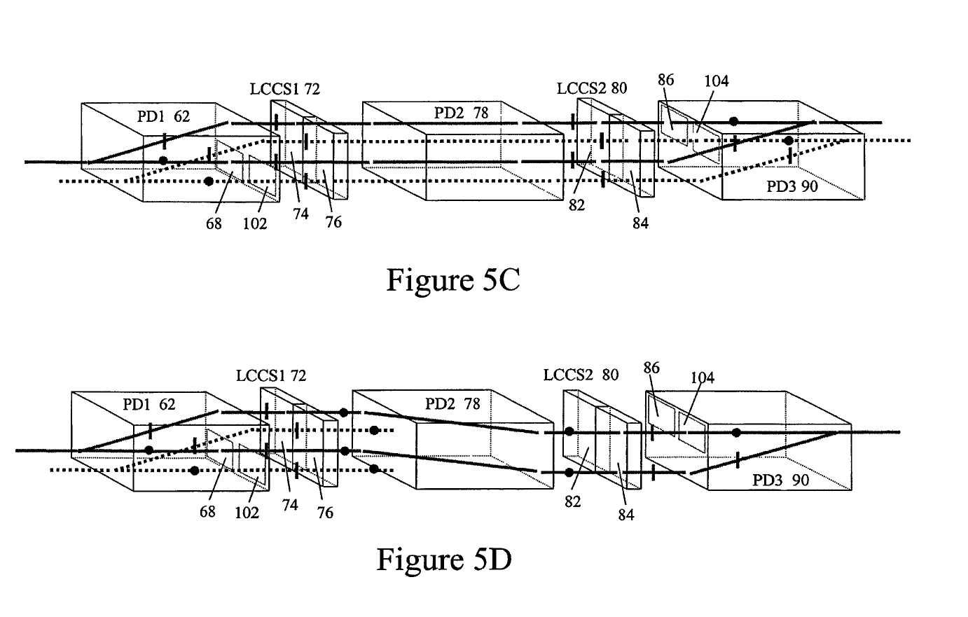

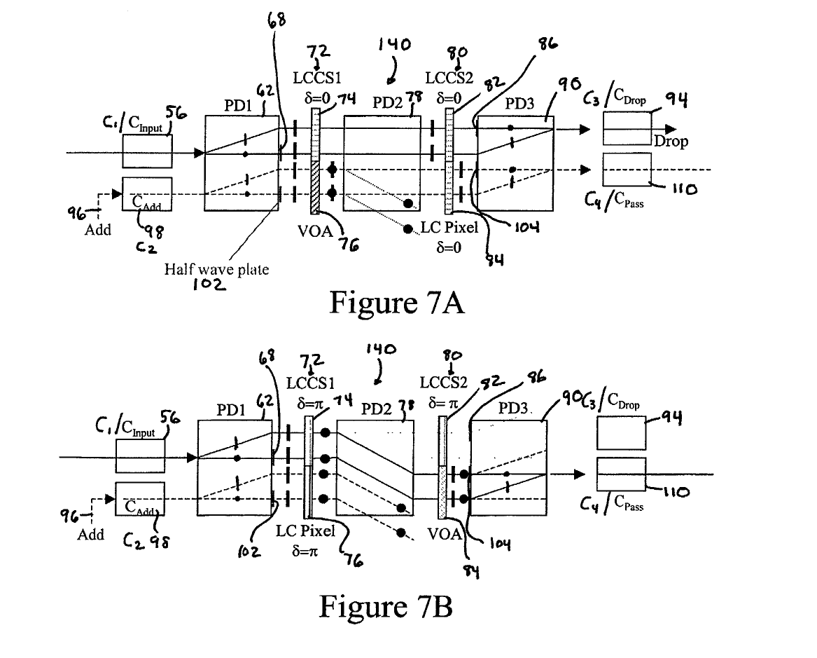

FIG. 5A is a schematic illustration of an example of a single channel optical add/drop module switch rail 50 in accordance with the invention in a first switching state that performs add/drop functions and FIG. 5B is a schematic illustration of the single channel optical add/drop module switch rail 50 in accordance with the invention in a second switching state that allows the incoming signal to pass through the optical add/drop module. As shown, a multiple wavelengths input signal 52 (λ₁, λ₂, λ₃, . . . , λₙ) is guided through a first fiber 54 of a dual fiber collimator (Cᵢₙₚᵤₜ) 56 to a dielectric thin film filter (F₁₁) 58. The filter passes a signal of a single wavelength (λ₁ in this example) through the filter, while it reflects the rest of wavelength signals (λ₂, λ₃, . . . , λₙ) to a second fiber 60 of Cᵢₙₚᵤₜ. Thus, this single channel optical add/drop module 50 performs the function of selecting a particular wavelength signal from the WDM signal and then adding/dropping that signal based on the control signals. The single wavelength signal is then fed into a birefringent element (PD1) 62, such as a birefringent crystal made out of a well known material, such as Calcite, YVO₄, Rutile, etc. The birefringent element PD1 splits the incoming signal with wavelength λ₁ into two orthogonal polarization signals 64, 66 wherein the vertically polarized signal is shown for illustration purposes as a straight vertical line and the horizontally polarized signal is shown as a dot. As is well known, the birefringent element separates the two orthogonally polarized signals by a walk-off angle determined by the orientation of the axes of the element and physical characteristics of the birefringent element. The largest walk-off angle is obtained when the incident angle with respect to the optical axis of the birefringent element is θ=tan⁻¹(nₑ/nₒ) with the direction of the O ray in the O, E rays plane, where nₑ and nₒ are refractive indices of E and O ray, respectively. For this particular birefringent element, PD1, the walk-off direction is upward so that the two orthogonally polarized signals 64, 66 are separated by a walk-off angle from each other as shown. This characteristics is also shown in FIGS. 5C and 5D and in FIGS. 7A and 7B.

A half-wave plate (HWP) 68, whose axes are at a 45° angle with respect to both polarization states, rotates one of the two optical signals output from PD 1 so it has the same polarization as the other (as shown by the two signals with the same vertical line indicating the same polarization). Both signals 69, 70 are then passed through an electrically controlled retarder (LCCS1) 72 that has two pixels 74, 76 as shown. The voltage applied to each pixel of the electrically controlled retarder can be independently controlled so that the retarder can rotate the signals passing through it or pass the signals through unaffected. In a preferred embodiment, a liquid crystal (LC) cell stack may be the electrically controlled retarder since LC materials have large birefringence that enables use of a very thin layer of material to obtain the desirable retardation. In addition, the LC cell is readily available due to its relatively mature technology. However, electro-optic (EO) crystals (e.g. LiNbO₃) and polymers may also be used as electrically controlled retarder. Furthermore, a magneto-optic crystal device that is an electrically controlled rotator can also be used to achieve similar functionality.

If the retardance of LCCS1 72 is set to zero, as shown in FIG. 5A, the polarization of the two optical signals 69, 70 do not change and the two signals are directed to a second birefringent element (PD2) 78. Due to the polarization of the signals, they pass straight through that birefringent element. If the retardance of the LCCS1 72 is set to π(as shown in FIG. 5B), then the two optical signals 69, 70 are rotated by LCCS1 72 and are deflected toward the front side of the second birefringent element PD2 78 as shown in FIG. 5B. This is also shown in FIGS. 5C and 5D. Returning to FIG. 5A, once the two signals pass through the second birefringent element 78 as shown, they strike a second electrically controller retarder LCCS2 80 having a first pixel 82 and a second pixel 84 as shown. If the retardance of LCCS2 80 is set to zero (as shown in FIG. 5A), the polarization of the two optical signals are not changed. Then, one of the signals strikes a halfwave plate 86 so that the polarization of that signal 88 is rotated as shown in FIG. 5A. Then, the two signals enter a third birefringent element PD3 90 and are recombined as a drop signal 92 by the birefringement element due to the walk-off direction of this third birefringent element. The drop signal is then fed into a collimator C_{Drop} 94 and dropped out of the input signal. In this manner, the input signal λ₁ is dropped as shown in FIG. 5A.

The same module 50 may also be used to add a signal into the output wherein an input signal 96 of the same wavelength (λ₁ in this example) is fed into a collimator C_{Add} 98. The input signal then is fed into the first birefringent element 62 which separates the two different polarization signals as described above. A bottom signal 100 exits the birefringent element 62 and passes through a halfwave plate 102 so that the polarization of both signals is the same. The two signals then pass through the pixel 76 (which is set to zero, pixel 76 is a front pixel as shown in the 3-D view of FIGS. 5C and 5D) of LCCS1 72 and are not rotated so that the signals then pass through the second birefringent element 78 unaltered. The voltage applied to the pixel 76 of LCCS1 can also be altered in order to attenuate the added signal. The two signals then pass through the lower pixel 84 of LCCS2 80 and are again unchanged. The upper signal then passes through a halfwave plate 104 which rotates its polarization and enters the third birefringent element 90. The two signals are then recombined together as shown by the third birefringent element 90 into a combined optical signal 106 that is then passed though a wavelength filter F₁₂ 108 and a collimator C_{Pass} 110 so that it can be added into the output signal. If the retardance of pixel 76 is pre-set at π, the Add signal is blocked unless the driving voltages of pixel 76 are altered. Therefore, at Add/Drop switching state, we can select to perform add and drop functions either simultaneously or independently. The ability to add and drop independently is an extra bonus for optical networks management. As described below in more detail, an array of these single channel optical add/drop modules 50 can be combined together to form a reconfigurable, multiple wavelength optical add/drop module that is easy to manufacture and cost effective.

FIG. 5B shows the same single channel optical add/drop module 50 when an input signal 52 passes through the optical add/drop module 50 unaffected. In this mode of operation, LCCS1 72 and LCCS2 80 are controlled and set to π to rotate the polarizations of the signals. In operation, the input signal is split into orthogonally polarized signals as shown. As above, one of the signals passes through the halfwave plate 68 and is rotated so that both signals have the same polarization as the signals enter LCCS1 72 wherein both signals are rotated as shown to be horizontally polarized. Due to the horizontal polarization of both signals and the orientation of PD2 78 and its optical axis, both signals walk off toward front side of PD2 78 as shown in FIGS. 5C and 5D. The two signals then exit PD2 78 and strike the front pixel 84 of LCCS2 80 as shown and are both rotated (so that both are vertically polarized in this example). One of the signal then passes through the halfwave plate 104 so that the signals have different polarization and are therefore combined by PD3 90 as shown so that both signals pass through the filter 108 and exit through the collimator 110 as shown. Thus, the signal passes through the module 50 unaffected. As shown, if an added signal 96 is fed into the module 50 in this mode of operation, it is discarded by the PD2 78 as shown in FIG. 5B. In accordance with the invention, either pixel 74, 76, 82, 84 of either LCCSs 72, 80 may be used to attenuate a signal passing through it by controlling the voltage applied to each pixel since each pixel may have an independent voltage applied to it or both pixels of each LCCS may also have the same voltage applied to each pixel. In more detail, when there is no voltage applied to a particular type of LCCS, there is a π phase shift when both rays pass through the pixel. There will be a zero phase shift (the rays are unaffected) if a high voltage signal (e.g., 24 volts) is applied to the pixel. The variable optical attenuator function is realized by adjusting the voltage applied within the 0 to 24 volt range. Now, the first embodiment of a multi-channel, multiple wavelength reconfigurable optical add/drop module will be described that is an array of the above optical add/drop modules shown in FIGS. 5A and 5B.

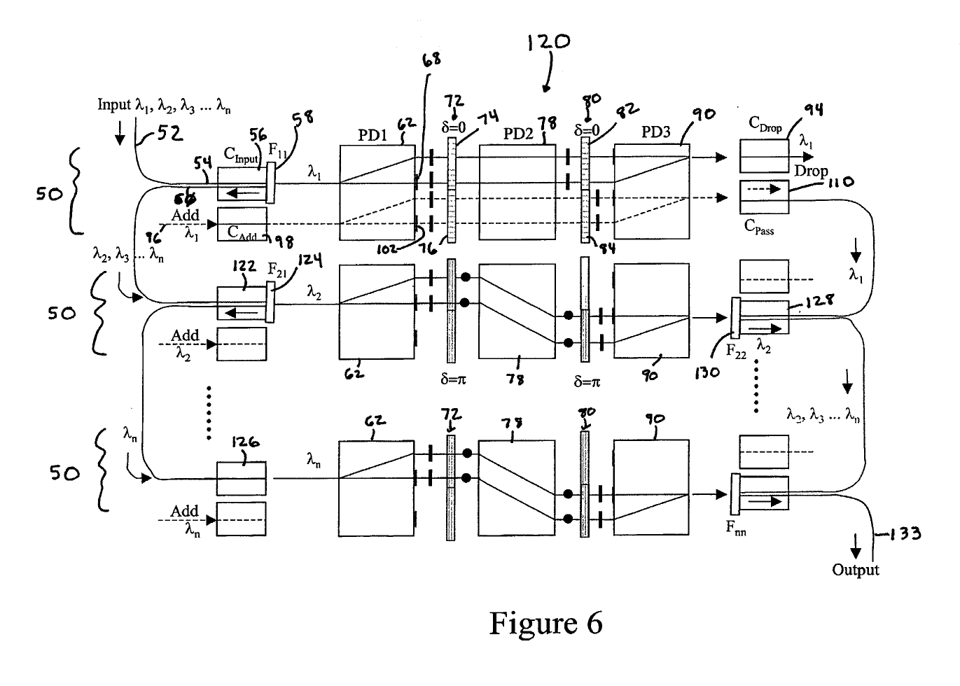

FIG. 6 is a schematic illustration of a first embodiment of a multi-channel reconfigurable optical add/drop module 120 in accordance with the invention consisting of an array of single channel optical add/drop module switch rails 50 wherein each channel handles a different wavelength. In this diagram, the elements of each optical add/drop module 50 are the same as those shown in FIGS. 5A and 5B and therefore their function and operation will not be described in detail herein. To improve the clarity of this figure, the reference numerals associated with the signals within the optical add/drop modules 50 are not shown and the reference numerals for all of the elements in the optical add/drop modules 50 are not shown. Returning to FIG. 6, there may be a optical add/drop module for each wavelength (λ₁, λ₂, λ₃, . . . , λₙ) As above, a multiple wavelength input signal 52 is fed into the module 120. In particular, the multiple wavelengths input signal 52 is guided through the first fiber 54 of a dual fiber collimator (Cᵢₙₚᵤₜ) 56 to a dielectric thin film filter (F₁₁) 58. The filter passes a signal of a single wavelength (λ₁ in this example) through the filter while the other wavelength signals (λ₂, λ₃, . . . , λₙ) are reflected by the filter to a second fiber 60 of Cᵢₙₚᵤₜ which is fed into a second module as shown. At the second module, the signal is fed into a second dual fiber collimator 122 and strikes a second dielectric thin film filter (F₂₁) 124 which passes a single wavelength signal (λ₂ in this example) while the other wavelength signals are reflected and passed onto other collimators until the signal has only λₙ wavelength light which is fed into a last collimator 126 as shown. In this manner, the incoming multiple wavelength optical signal is split into one or more 10 individual signals having a single wavelength wherein each single wavelength optical signal is separately processed by a optical add/drop module 50 as shown. In this manner, each different wavelength signal may be independently and separately processed since the signals are all physically separated from each other. Accordingly, each wavelength goes through an optical add/drop module 50 and it is either passed to the output fiber or dropped through C_{Drop} collimator 94 as shown. At the output of the multiple wavelength module 120, signals that are passing through the modules 50 unaffected are output from the collimator 110 and fed to the a next collimator 128 as shown. The next collimator 128 has a dielectric thin film filter 130 (F₂₂ in this example) that reflects the first wavelength optical signal and passes the second wavelength optical signal so that the two signals are combined together. In this manner, the signals from all of the modules 50 are combined back together and output as a multiple wavelength signal 133. Thus, the multiple channel module 120 is able to separately and independently process each optical signal by separating the input signal into single wavelength signals, processing each single wavelength signal and recombining the single wavelength signals into an output signal. In the mean time, the capability of variably attenuating the signal for each channel offers channel-equalizing function in the R-OADM module, which is also an important function in the WDM optical system.

In more detail, each switch rail 50 processes one wavelength or channel as described above in more detail with reference to FIGS. 5A and 5B. As described above, the switch performs add/drop function or simply directs the optical signal to the output (C_{Pass}). Due to the flexibility of liquid crystal technology, the liquid crystal pixels can also be configured as variable optical attenuators (VOAs) as described above to perform a channel equalization function during the optical add/drop multiplexing. Now, a by-passed 2×2/NOA switch rail in accordance with the invention will be described that may also be used to create a reconfigurable add/drop module in accordance with the invention.

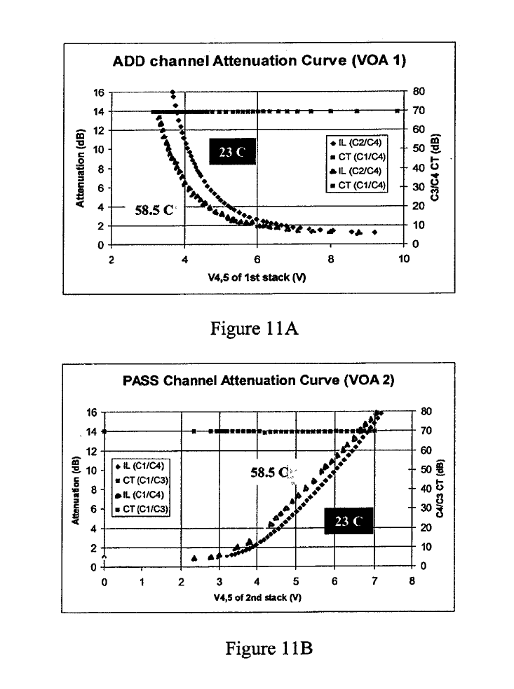

FIG. 7A is a schematic illustration of a by-passed 2×2/VOA switch rail 140 in accordance with the invention that is actually a single channel optical add/drop module rail that handles broadband signals in a first switching state that performs add/drop functions and FIG. 7B is a schematic illustration of the by-passed 2×2/VOA switch rail 140 in accordance with the invention in a second switching state that allows the incoming signal to pass through the optical add/drop module. The switch rail 140 has the same elements as the optical add/drop module 50 described above and like elements will be labeled with like reference numerals and will not be described herein in detail. In this switch rail, the voltages applied to each pixel of each of the LCCSs 72, 80 are controlled to provide variable optical attenuation as shown. As shown in FIG. 7A, each pixel 74, 76 of LCCS1 72 may be operated as a variable optical attenuator (to attenuate a signal passing through either pixel) and LCCS2 80 may have the same voltage applied to each pixel 82, 84 such that each pixel does not rotate the signal passing through the pixel. In the mode of operation shown in FIG. 7A, an input signal is dropped and an add signal may be added. In FIG. 7B, the pixel 76 of LCCS1 72 and pixel 82 of LCCS2 80 may have the same voltage applied and each rotate the polarization of the signal by 90° as shown while the pixels 74 of LCCS1 72 and 84 of LCCS2 80 may have variable voltages applied to each pixel to provide the variable optical attenuation. In the mode of operation shown in FIG. 7B, the input signal passes through the module 140 unaffected and the add signal is lost and cannot be added into the signal. One example of VOA working function is shown in FIGS. 11A and 11B. In the mode of operation shown in FIG. 7A, the rotator's voltage of pixel 76 of LCCS1 72 (LCCS is actually a multi-cell stack that includes one or more rotators and one or more compensators) is turned on and set at high voltage (such as 24 Vpp) so that the retardance of the pixel is zero and the ADD signal passes through onto collimator Cₚₐₛₛ 110. As the voltage decreases, the retardance of pixel 76 of LCCS1 72 increases and therefore the attenuation increases as shown in FIG. 11A. In the mode of operation shown in FIG. 7B, the rotator's voltage of pixel 84 of LCCS2 80 is set at low voltage (normally 0 V) for the input signal to pass onto collimator Cₚₐₛₛ 110. In this case the attenuation is increased with increasing voltage of pixel 84 as shown in FIG. 11B. Now, a multiple channel reconfigurable optical add/drop module that uses the above by-passed 2×2/VOA switch rail will be described.

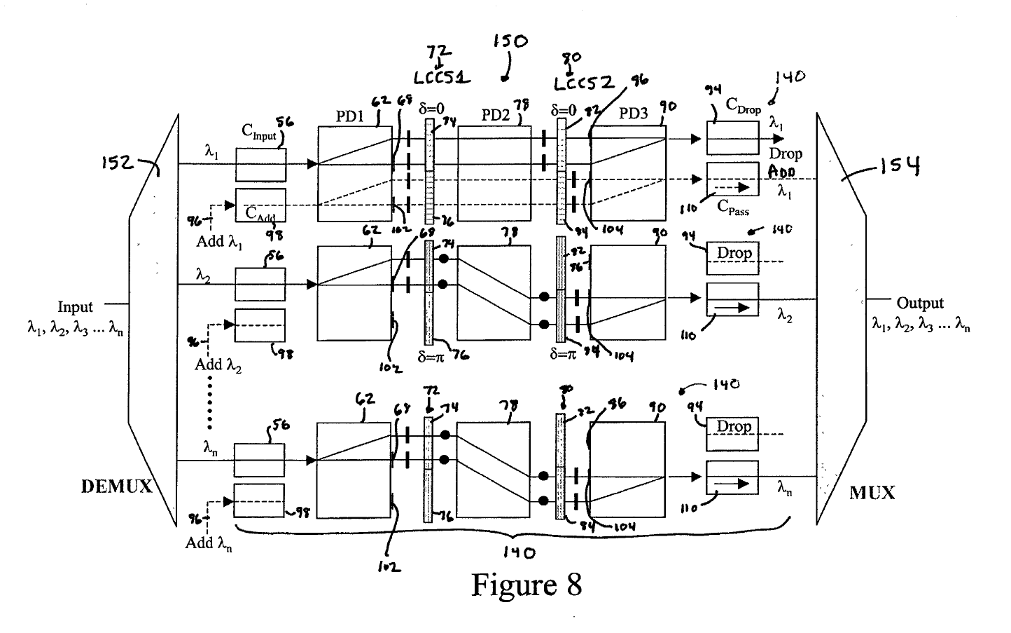

FIG. 8 is a schematic illustration of a second embodiment of a multi-channel reconfigurable optical add/drop module 150 in accordance with the invention consisting an array of by-passed 2×2/VOA switch rails 140 and a pair of multiplexers/demultiplexers. In particular, a well known demultiplexer 152 may receive an input signal having multiple wavelengths (λ₁, λ₂, λ₃. . . , λₙ) and separate the input signal into a plurality of single wavelength signals as shown. The single wavelength outputs from the demultiplexer may each be fed into a switch rail 140 such that each switch rail handles only a single wavelength signal as shown. Again, this embodiment provides a separate, independent switching rail for each wavelength signal which reduces crosstalk. Once the switching rails 140 have performed their add/drop/pass operations on each wavelength signal, the outputs signals are fed into a multiplexer 154 that combines the single wavelength signals into a single multiple wavelength signal that is output. Since the operation of each switching rail 140 is described above, it will not be described here in any detail. In the example shown in FIG. 8, the original first wavelength signal (λ₁) is dropped (based on the voltages applied to the pixels of the LCCS1 and LCCS2) in favor of the added first wavelength signal (Add λ₁) while the other original wavelength signals (λ₂, λ₃ . . . , λₙ are passed through their respective switching rails 140 (based on the voltages applied to the pixels of LCCS1 and LCCS2). Thus, the multiplexed output signal in this example has the following wavelength components: Add λ₁, λ₂, λ₃ . . . , λₙ. Obviously, the reconfigurable module 150 can add/drop or pass any wavelength signal since each switch rail 140 is independently controllable. Now, another embodiment of the multiple channel reconfigurable optical add/drop module will be described.

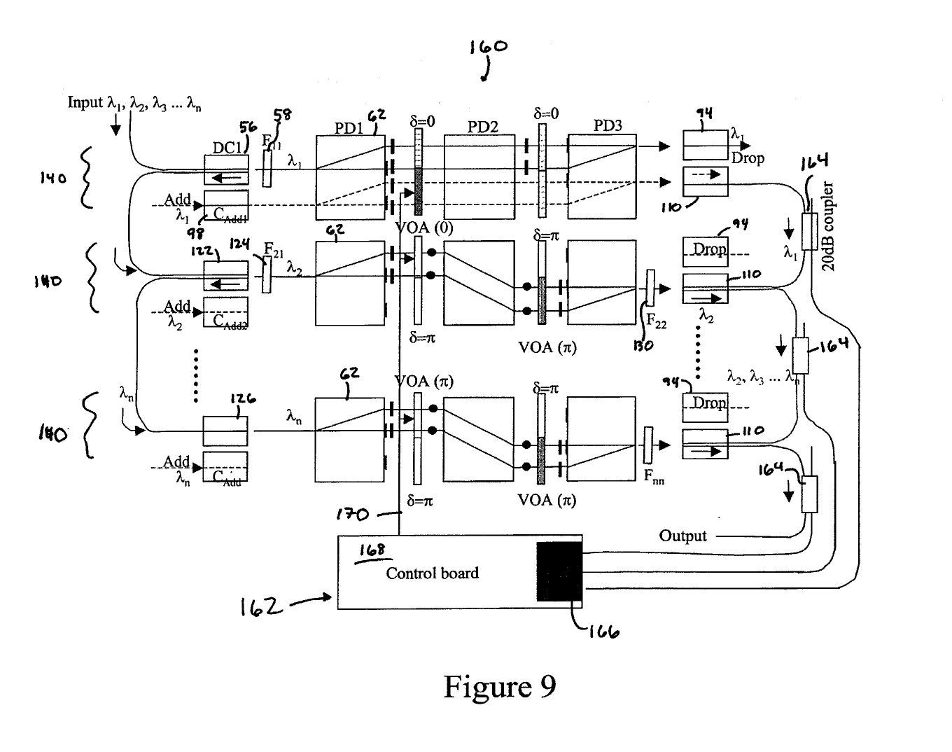

FIG. 9 is a schematic illustration of a third embodiment of a multi-channel reconfigurable optical add/drop module 160 in accordance with the invention consisting an array of single channel optical add/drop module switch rails 140 and a feedback system 162. The module 160 comprises several switching rails 140 wherein each switching rail 140 processes a single wavelength signal as shown and as described above. The multiple wavelength input signal is distributed as single wavelength signals to each switching rail 140 as described above with respect to FIG. 6 and therefore will not be described here. In the example shown in FIG. 9, the first wavelength signal is dropped in favor of the added first wavelength signal (based on the voltages applied to the LCCSs) and the other wavelength signals pass through the switching rails 140 unaffected so that the output signal has the same components as described above with reference to FIG. 8.

Since the electrical field applied on each liquid crystal pixel controls birefringence of the liquid crystal material for that pixel, the optical transmission of the liquid crystal cells varies with the voltage being applied across them. In this invention, a relationship of attenuation of a switch rail versus the voltage applied across the liquid crystal pixels is pre-determined and calibrated. The relationship may be then used as a platform for designing the feedback system 162 to dynamically control the attenuation level for each channel.

In the embodiment shown in FIG. 9, the feedback system 162 may comprise a 20 dB coupler 164 at the output of each switching rail 140 as shown. The output of the smaller power (−20 dB) from the couplers 164 maybe fed into an array of photodetectors 166 that are part of a control board 168. The control board may include one or more pieces of circuit and software that process the incoming photodetector signals and analyze them. The combination of each coupler and its corresponding photodetector is used to monitor the power level of each channel, as illustrated in FIG. 9. Based upon the pre-determined well known attenuation/voltage relationship, the control board may send out a proper voltage waveform over a control wire 170 to the LCCS which is operating as a variable optical attenuator (LCCS1 72 in this example) to designated liquid crystal pixels to achieve desirable optical attenuation. As above, there are independent control signals to each pixel so that each pixel may be independently controlled. The channel equalization of the R-OADM module is then realized.

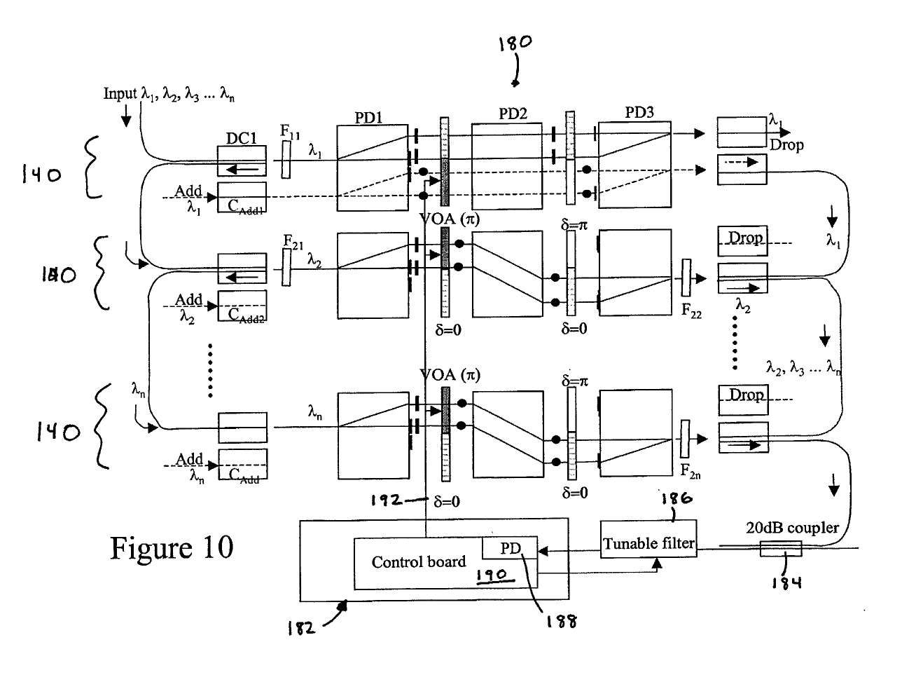

FIG. 10 is a schematic illustration of a fourth embodiment of a multi-channel reconfigurable optical add/drop module 180 in accordance with the invention consisting an array of single channel optical add/drop module switch rails 140 and a different feedback system 182. The operation of the switching rails 140 and the overall operation of the module 180 and its elements are similar to the switching rails, module and elements shown above and therefore will not be described here. In this embodiment, the feedback system 182 may include a coupler 184 that is coupled to the output signal from the module 180, a tunable filter 186 coupled to the output of the coupler 184, a photodetector 188 coupled to the output of the filter 186 and a control board 190 on which the photodetector 188 is located. As above, the control board may execute one or more pieces of circuit and software that process the photodetector signal and analyze the signal to generate control signals over a control line 192 to the LCCS operating as the variable optical attenuator. The tunable filter is controlled by signals from a software module being executed by the control board. In operation, the tunable filter 186 scans the wavelength range of the incoming signal in response to control signals. Thus, at different times, the tunable filter measures the power of a particular wavelength signal. Thus, the power level at each channel wavelength is determined and then the control board adjusts the voltage across liquid crystal pixels to realize channel equalization as above.

While the foregoing has been with reference to a particular embodiment of the invention, it will be appreciated by those skilled in the art that changes in this embodiment may be made without departing from the principles and spirit of the invention, the scope of which is defined by the appended claims.

1. A re-configurable optical add/drop multiplexing module for a multiple wavelength incoming signal, comprising:
an array of wavelength selective switch rails that are connected together so that each switch rail processes an optical signal having a single wavelength and the array of switch rails process the incoming multiple wavelength signal; and
wherein each switch rail further comprises a dual fiber collimator with a WDM filter at a particular wavelength that receives a multiple wavelength signal and selects a particular wavelength signal, a single fiber collimator for adding a signal having the particular wavelength, a first birefringent element that splits the particular wavelength signal into orthogonal polarizations having a first polarization and a second polarization, a first rotator that receives the orthogonal polarization signals and performs one or more of switching the polarization of one of the orthogonal polarization signals and attenuates one of the orthogonal polarization signals, a second birefringent element that deflects the path of the orthogonal polarization signals that exit the first rotator, a second rotator that receives the orthogonal polarization signals from the second birefringent element and performs one or more of switching and attenuation, a third birefringent element that receives the orthogonal polarization signals from the second rotator and recombines the orthogonal polarization signals, a regular collimator to collects a signal being dropped, and a dual fiber collimator with a WDM filter at the same wavelength that passes the particular wavelength signal.

2. The module of claim 1, wherein first birefringent element further comprises a first half-wave plate attached to the exterior of the first birefringent element to change the phase of one of the polarizations passing through the first birefringent element and wherein the third birefringent element further comprises a second half-wave plate attached to the exterior of the third birefringent element to change the phase of one of the polarizations passing through the third birefringent element.

3. The module of claim 2, wherein the first half-wave plate is attached to the exit point of one signal from the first birefringent element.

4. The module of claim 3, wherein the second half-wave plate is attached to the entry point of one signal to the third birefringent element.

5. The module of claim 1 further comprising a feedback system that controls the attenuation of the rotator to achieve channel equalization.

6. The module of claim 1 further comprising an active compensation mechanism using electronic feedback as a new way of driving liquid crystal cells.

7. The module of claim 1, wherein each birefringent element comprises a block of birefringent crystal.

8. The module of claim A+7, wherein each block of birefringent crystal comprise a material selected from a group consisting of one of rutile, calcite, and yttrium vanadate (YVO₄).

9. The module of claim 1 wherein said rotators may have four pixels or two pixels if used with half-wave plates.

10. The module of claim 1, wherein the first and second rotator further comprises a liquid crystal cell stack.

11. The module of claim 1, wherein the first and second rotator further comprises an electro-optical crystal.

12. The module of claim 1, wherein the first and second rotator further comprises a magneto-optical device.

13. The module of claim 5, wherein the feedback system further comprises one or more couplers that each receive each single wavelength signal, one or more sensors that receive the signals from the one or more couplers and means for generating a control signal for a rotator in each switch rail in order to independently control the rotation of each switch rail.

14. The module of claim 5, wherein the feedback system further comprises a coupler that receives the multiple single wavelength signals from the switch rails, a tunable filter that selects a particular wavelength signal at a particular time, a sensor that receives the particular wavelength signal at the particular time and means for generating a control signal at the particular time to control the rotator associated with the particular wavelength signal.

15. A re-configurable optical add/drop multiplexing module for a multiple wavelength incoming signal, comprising:
a wavelength de-multiplexer that divides the incoming multiple wavelength signal into a plurality of single wavelength signals;
an array of switch rails that are connected together so that each switch rail processes an optical signal having a single wavelength and the array of switch rails process the incoming multiple wavelength signal;
wherein each switch rail further comprises a single fiber collimator for adding a signal having the particular wavelength, a first birefringent element that splits the particular wavelength signal into orthogonal polarizations having a first polarization and a second polarization, a first rotator that receives the orthogonal polarization signals and performs one or more of switching the polarization of one of the orthogonal polarization signals and attenuates one of the orthogonal polarization signals, a second birefringent element that deflects the path of the orthogonal polarization signals that exit the first rotator, a second rotator that receives the orthogonal polarization signals from the second birefringent element and performs one or more of switching and attenuation, a third birefringent element that receives the orthogonal polarization signals from the second rotator and recombines the orthogonal polarization signals to generate a particular wavelength output signal, a regular collimator to collects a signal being dropped; and
a wavelength multiplexer that combines the particular wavelength output signals from the array of switch rails to generate a multiple wavelength output signal.

16. The module of claim 15, wherein first birefringent element further comprises a first half-wave plate attached to the exterior of the first birefringent element to change the phase of one of the polarizations passing through the first birefringent element and wherein the third birefringent element further comprises a second half-wave plate attached to the exterior of the third birefringent element to change the phase of one of the polarizations passing through the third birefringent element.

17. The module of claim 16, wherein the first half-wave plate is attached to the exit point of one signal from the first birefringent element.

18. The module of claim 17, wherein the second half-wave plate is attached to the entry point of one signal to the third birefringent element.

19. The module of claim 15 further comprising a feedback system that controls the attenuation of the rotator to achieve channel equalization.

20. The module of claim 15 further comprising an active compensation mechanism using electronic feedback as a new way of driving liquid crystal cells.

21. The module of claim 15, wherein each birefringent element comprises a block of birefringent crystal.

22. The module of claim 21, wherein each block of birefringent crystal comprise a material selected from a group consisting of one of rutile, calcite, and yttrium vanadate (YVO₄).

23. The module of claim 15 wherein said first and second rotator may have four pixels or two pixels if used with half-wave plates.

24. The module of claim 15, wherein the first and second rotator further comprises a liquid crystal cell stack.

25. The module of claim 15, wherein the first and second rotator further comprises a electro-optical crystal.

26. The module of claim 15, wherein the first and second rotator further comprises a magneto-optical device.

27. The module of claim 19, wherein the feedback system further comprises one or more couplers that each receive each single wavelength signal, one or more sensors that receive the signals from the one or more couplers and means for generating a control signal for a rotator in each switch rail in order to independently control the rotation of each switch rail.

28. The module of claim 19, wherein the feedback system further comprises a coupler that receives the multiple single wavelength signals from the switch rails, a tunable filter that selects a particular wavelength signal at a particular time, a sensor that receives the particular wavelength signal at the particular time and means for generating a control signal at the particular time to control the rotator associated with the particular wavelength signal.

29. A re-configurable optical add/drop multiplexing module having a connected array of wavelength selective switch rails, each switch rail comprising:
a dual fiber collimator with a WDM filter at a particular wavelength that receives a multiple wavelength signal and selects a particular wavelength signal;
a single fiber collimator for adding a signal having the particular wavelength;
a first birefringent element that splits the particular wavelength signal into orthogonal polarizations having a first polarization and a second polarization;
a first rotator that receives the orthogonal polarization signals and performs one or more of switching the polarization of one of the orthogonal polarization signals and attenuates one of the orthogonal polarization signals;
a second birefringent element that deflects the path of the orthogonal polarization signals that exit the first rotator;
a second rotator that receives the orthogonal polarization signals from the second birefringent element and performs one or more of switching and attenuation;
a third birefringent element that receives the orthogonal polarization signals from the second rotator and recombines the orthogonal polarization signals;
a regular collimator to collects a signal being dropped; and
a dual fiber collimator with a WDM filter at the same wavelength that passes the particular wavelength signal.

30. The module of claim 29, wherein first birefringent element further comprises a first half-wave plate attached to the exterior of the first birefringent element to change the phase of one of the polarizations passing through the first birefringent element and wherein the third birefringent element further comprises a second half-wave plate attached to the exterior of the third birefringent element to change the phase of one of the polarizations passing through the third birefringent element.

31. The module of claim 30, wherein the first half-wave plate is attached to the exit point of one signal from the first birefringent element.

32. The module of claim 31, wherein the second half-wave plate is attached to the entry point of one signal to the third birefringent element.

33. The module of claim 29 further comprising a feedback system that controls the attenuation of the rotator to achieve channel equalization.

34. The module of claim 29 further comprising an active compensation mechanism using electronic feedback as a new way of driving liquid crystal cells.

35. The module of claim 29, wherein each birefringent element comprises a block of birefringent crystal.

36. The module of claim 35, wherein each block of birefringent crystal comprise a material selected from a group consisting of one of rutile, calcite, and yttrium vanadate (YVO₄).

37. The module of claim 29 wherein said first and second rotators may have four pixels or two pixels if used with half-wave plates.

38. The module of claim 29, wherein the first and second rotator further comprises a liquid crystal cell stack.

39. The module of claim 29, wherein the first and second rotator further comprises an electro-optical crystal.

40. The module of claim 29, wherein the first and second rotator further comprises a magneto-optical device.

41. A re-configurable optical add/drop multiplexing module for adding/dropping optical signals from an incoming multiple wavelength signal, comprising
one or more broadband switch rails;
each switch rail comprising two regular collimators as input ports, first block of birefringent crystal that splits incoming light into e- and o- rays, first multi-pixel liquid crystal (LC) cell stack that either switches or attenuates the light beam, a polarization dependent beam path deflector comprising a second block of birefringent crystal, second multi-pixel liquid crystal (LC) cell stack that performs switching and attenuating functions, third block of birefringent crystal that combines e- and o- rays, and two regular collinators as output ports;
a demultiplexer that separates the incoming multiple wavelength signal into one or more single wavelength signals that are input into a respective one of the switch rails; and
a multiplexer that receives the single wavelength output signals from the one or more switch rails and recombines the multiple output signals into a multiple wavelength output signal.

42. A re-configurable optical add/drop multiplexing module for a multiple wavelength incoming signal, comprising:
an array of wavelength selective switch rails that are connected together so that each switch rail processes an optical signal having a single wavelength and the array of switch rails process the incoming multiple wavelength signal; and
wherein each switch rail further comprises means for selecting a particular wavelength signal from the incoming multiple wavelength signal, means for adding a signal having a particular wavelength, means for splitting the particular wavelength signals into orthogonal polarizations signals having a first polarization and a second polarization, means for controllably retarding the orthogonal polarization signals having a first mode in which the orthogonal polarized signals are not rotated and having a second mode in which the orthogonal polarization signals are rotated, means for deflecting the path of the signals that exit the retardation means, second controllable retardation means that receives the signals from the deflecting means having a first mode in which the orthogonal polarized signals are not rotated and having a second mode in which the orthogonal polarization signals are rotated, and means for recombining the signals exiting the second retardation means, wherein, in the first mode of operation, the particular wavelength signal is dropped and the added particular wavelength signal is output from the switch rail and wherein, in the second mode of operation, the particular wavelength signal is output from the switch rail and the added particular wavelength signal is not output.

43. A re-configurable optical add/drop multiplexing module for adding/dropping optical signals from an incoming multiple wavelength signal, comprising
means for separating the incoming multiple wavelength signal into one or more single wavelength signals that are input into one or more switch rails;
wherein each switch rail further comprises means for receiving a particular wavelength signal from the incoming multiple wavelength signal, means for adding a signal having a particular wavelength, means for splitting the particular wavelength signals into orthogonal polarizations signals having a first polarization and a second polarization, means for controllably retarding the orthogonal polarization signals having a first mode in which the orthogonal polarized signals are not rotated and having a second mode in which the orthogonal polarization signals are rotated, means for deflecting the path of the signals that exit the retardation means, second controllable retardation means that receives the signals from the deflecting means having a first mode in which the orthogonal polarized signals are not rotated and having a second mode in which the orthogonal polarization signals are rotated, and means for recombining the signals exiting the second retardation means, wherein, in the first mode of operation, the particular wavelength signal is dropped and the added particular wavelength signal is output from the switch rail and wherein, in the second mode of operation, the particular wavelength signal is output from the switch rail and the added particular wavelength signal is not output; and
means for performing add and drop functions independently; and
means for recombining the output signals from the one or more switch rails into a multiple wavelength output signal.
